(19) United States
(12) Patent Application Publication
(10) Pub. No.: US 2003/0146157 A1
(43) Pub. Date: Aug. 7, 2003

(54) Rotating reverse osmosis filtration

(76) Inventor: Richard M. Lueptow, Evanston, IL (US)

Correspondence Address: Mr. Edward J. Timmer, Walnut Woods Centre, 5955 W. Main Street, Kalamazoo, MI, 49009, US

(21) Appl. No.: 10/060,393

(22) Filed: Feb. 1, 2002

(51) Int. Cl. B01D 61/02

(52) U.S. Cl. 210/652; 210/107; 210/321.65; 210/321.68; 210/637

(57) ABSTRACT

Reverse osmosis filtration is conducted using a rotatable inner body having an axis of rotation and a reverse osmosis filter member disposed on the inner body. An outer body is disposed about the inner body and spaced therefrom to provide an annulus between an annular outer surface of the filter member and an annular inner surface of the outer body to receive a liquid to be filtered. A source of the liquid under pressure is communicated to an inlet to the annulus. The inner body is rotated at a rotational speed effective to generate Taylor or other vortices in the liquid in the annulus.

### CONTRACTUAL ORIGIN OF THE INVENTION

This invention was supported in part by funding from the Federal Government through NASA under Grant No. NAG9-1053. The Government may have certain rights in this invention.

### FIELD OF THE INVENTION

The present invention relates to rotating reverse osmosis filtration.

### BACKGROUND OF THE INVENTION

Osmosis is a process that involves interposing a stationary semipermeable membrane between a high concentration solution and a nearly pure liquid. The semi-permeable membrane permits the liquid to pass through it but not any solutes or particles. To achieve dynamic equilibrium, which corresponds to identical concentrations on both sides of the membrane, the liquid will pass through the membrane from the low concentration side to the high concentration side to bring the system closer to equilibrium.

In reverse osmosis processes, the direction of liquid flow through the membrane can be reversed by applying a high pressure to the high concentration side of the stationary membrane to force liquid through the membrane from the high concentration side to the low concentration side. Reverse osmosis separates the liquid from substances that can include ions, organic molecules and/or inorganic molecules. Reverse osmosis is capable of rejecting ions, bacteria, proteins, particles, dyes, and other constituents that have a molecular weight greater than that of the liquid, which can be water or any liquid. Reverse osmosis has been used to clarify wastewater, salt water, drinking water, and other liquids by removing salts and other impurities.

A significant problem in the application of reverse osmosis is the sensitivity to fouling of the membrane, which results in a decrease in permeate flux through the membrane. As filtration continues over time, the concentration of particles and solutes that are trapped on the membrane or concentrated near its surface increases. Particles may form a cake layer leading to permeate flux decline and subsequent membrane fouling. Solutes building up near the membrane surface result in concentration polarization that increases the pressure necessary to force the liquid through the membrane. Concentration polarization and membrane fouling are the most serious obstacles that have limited acceptance and usefulness of the reverse osmosis process.

To overcome membrane fouling, either the driving pressure across the membrane must be increased or the deposited solute layer or concentration polarization layer must be removed to maintain the flow rate through the membrane. Some particles and solutes can be dislodged by reversing the flow through the membrane, but this often is impractical or ineffective in reverse osmosis. Cross-flow filtration, where the input flows parallel to the surface of the membrane, reduces build up of particles and solute near the membrane by carrying them along with the flow. Nevertheless, particles and solutes can still accumulate near the membrane surface, eventually fouling it. Furthermore, increasing the cross-flow velocity in reverse osmosis filtration requires increased energy or may not be practical for other reasons.

Several devices have been studied to reduce membrane fouling in filtration processes such as microfiltration and ultrafiltration. For example, turbulence promoters in the feed channels, pulsing the feed flow over the filter membrane and designing a curved flow path so Dean vortices occur have been tried for filtration processes not related to reverse osmosis. For example, Belfort et al. in “The behavior of suspensions and macromolecular solutions in cross-flow microfiltration”, Journal of Membrane Science, 96, 1-58 (1994) describe several such techniques. For reverse osmosis filtration, a device using a circular reverse osmosis membrane configured as a rotating disk has been tried.

However, cross-flow filtration is used in most applications of reverse osmosis processes because of its simplicity. Yet cross-flow reverse osmosis filtration is severely limited in that the shear imparted to the liquid is directly coupled to the flow rate of liquid through the filtration device. The only way to decrease concentration polarization and membrane fouling in the cross-flow system is to increase the shear in the liquid by increasing the liquid flow rate. However, increasing the flow rate of the liquid causes the high concentration liquid to flow through the device faster, leaving less time for the pure liquid to pass through the membrane. Furthermore, higher flow rates require higher pressures, thereby increasing energy requirements of the cross-flow system.

### SUMMARY OF THE INVENTION

The present invention provides a rotating reverse osmosis filtration apparatus and method that reduces concentration polarization and fouling of the reverse osmosis filter member. Pursuant to an embodiment of the invention, reverse osmosis filtration is conducted using a rotatable inner body having an axis of rotation and a reverse osmosis (RO) filter member disposed on the inner body and having an outer surface. An outer body is disposed about the inner body and spaced therefrom such that an inner surface of the outer body and the outer surface of the RO filter member form an annulus therebetween to receive a liquid to be filtered. A source of the liquid under pressure is communicated to an inlet to the annulus. The liquid is under a high enough pressure (e.g. about 10 to about 40 atmospheres) in the annulus to cause permeate to flow by reverse osmosis through the RO filter member to a permeate outlet. The inner body is rotated preferably at a rotational speed effective to generate vortices in the high pressure liquid in the annulus. This rotation imparts angular velocity to the interior of the liquid in the annulus to generate shear in the liquid near the RO filter member. The vortices and shear remove contaminants on the RO filter member and/or in the concentration polarization layer near the RO filter member. The invention can be practiced to achieve substantial improvements in permeate flux and solute rejection even at low rotational speeds of the RO filter member.

In a particular embodiment of the invention, the liquid flows along a length of the annulus to a concentrate outlet located downstream of the inlet. The flow rate of liquid out of the concentrate outlet is controlled by pumping concentrate from the concentrate outlet at a controlled flow rate, all the while maintaining a high liquid pressure in the annulus to achieve reverse osmosis through the RO filter member. The high pressure liquid in the annulus and local conditions at the surface of the RO filter member control the flow rate of liquid through the RO filter member. The flow rate of liquid into the annulus is driven by a high pressure source, so that the flow rate is adequate to match the flow rate of liquid out of the concentrate outlet plus the flow rate of liquid through the RO filter member.

In another particular embodiment of the invention, the inner body includes an outer, permeate-collection surface on which a porous support member is disposed to support the RO filter member against the high pressure of the liquid in the annulus while permitting the permeate to pass to the collection surface on the inner body.

In another particular embodiment of the invention, the RO filter member includes opposite annular ends that are received and sealed in respective annular grooves to prevent high pressure liquid from bypassing the RO filter member around its ends.

In still another particular embodiment of the invention, the inner body is disposed on a rotatable shaft having a high pressure shaft seal at a shaft end to prevent leakage of the high pressure liquid.

The present invention will become more readily apparent from the following description taken with the following drawings.

### DESCRIPTION OF THE DRAWINGS

FIG. 1 is a schematic diagram of rotating reverse osmosis filtration apparatus in accordance with an embodiment of the invention.

FIG. 2 is a longitudinal sectional view of the apparatus.

FIG. 2A is a longitudinal sectional view of another embodiment of the apparatus.

FIG. 2B is a perspective view of the support sleeve showing opposite sides of the filter member to be received in a slot on the support sleeve.

FIG. 3 is a partial, enlarged sectional view of the apparatus showing the inner body and outer body.

FIG. 4 is a sectional view of the inner body showing each opposite annular end of the RO filter member sealed in a respective groove of an end cap.

FIG. 5A is graph of the effect of rotational speed on permeate flux with a transmembrane differential pressure of 1000 kPa. FIG. 5B is graph of the effect of rotational speed on total ion rejection. The triangle, square, etc. symbols represent experimental data, while the solid curves represent data from model calculations.

FIG. 6A is a contour diagram of net flux at different pressures and rotational speeds for 3 hours of operation. FIG. 6B is a contour diagram of total ion rejection at different pressures and rotational speeds for 3 hours. Black data circular points represent experimental data (with measured values in parenthesis), while the solid curves represent data from model calculation.

### DETAILED DESCRIPTION OF THE INVENTION

The present invention provides a rotating reverse osmosis filtration apparatus and method that can be practiced to reduce concentration polarization and fouling of the reverse osmosis filter member. The present invention can be practiced to separate a liquid from solute or other substances suspended or otherwise present therein. Such substances can include, but are not limited to, ions (e.g. dissolved metal ions), large macromolecules or very small organic molecules (e.g. urea molecules), inorganic molecules (e.g. minerals), bacteria, proteins, particles, dyes, and other constituents. The liquid can comprise wastewater, salt water, drinking water, chemical or industrial process water, and other liquids. The invention can be practiced to collect the permeate (pure liquid) and/or the concentrate, which for example may comprise a valuable solute concentrated from the liquid.

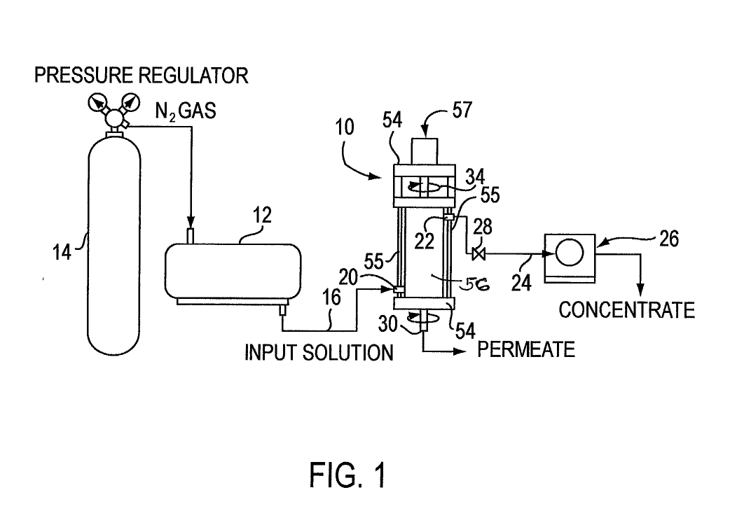

FIG. 1 is a schematic diagram of a rotating reverse osmosis apparatus in accordance with an illustrative embodiment of the invention. The apparatus includes a rotating reverse osmosis (RRO) filtration device 10 that is supplied with a liquid to be filtered from a liquid supply source or tank 12 that is gas pressurized by connection to a conventional gas cylinder or tank 14. The liquid is gas pressurized to provide a high enough pressure in the filtration device to achieve reverse osmosis filtering as described below and to force the liquid to flow from tank 12 into the RO filtration device 10. In lieu of a gas pressurized supply tank, the liquid to be filtered can be supplied from other sources such as a high-pressure pump, peristaltic pump and other suitable pumps.

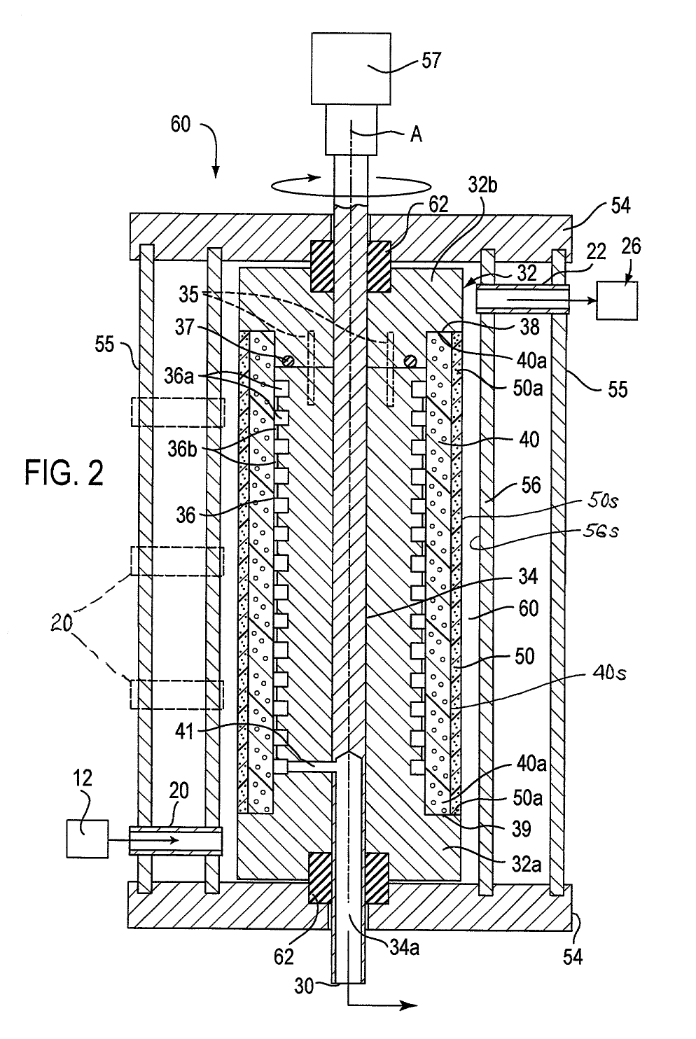

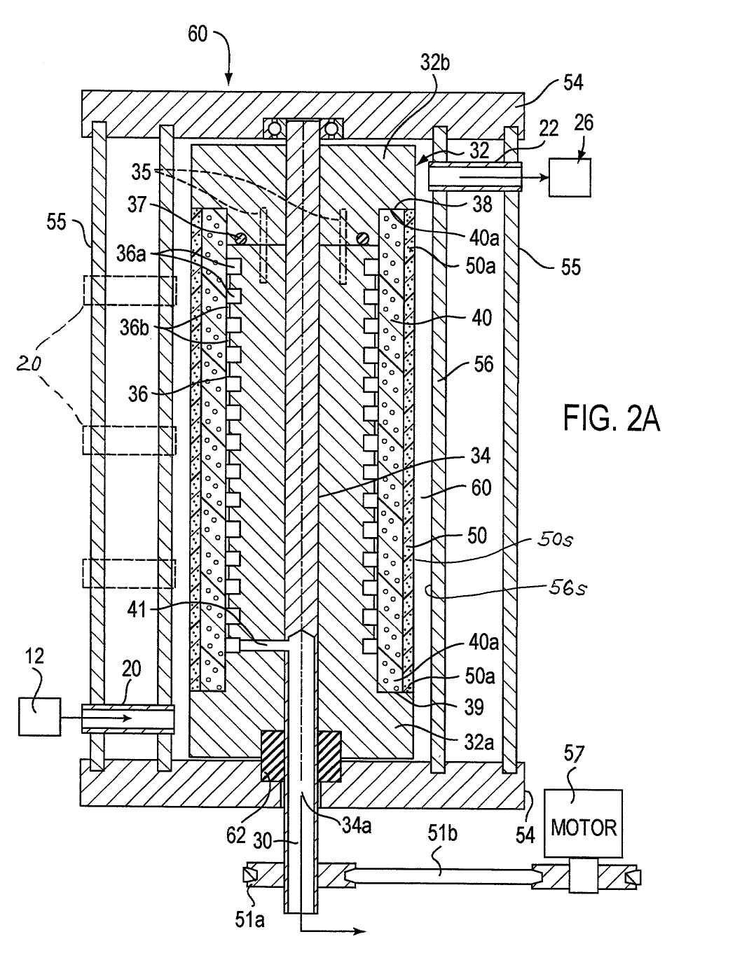

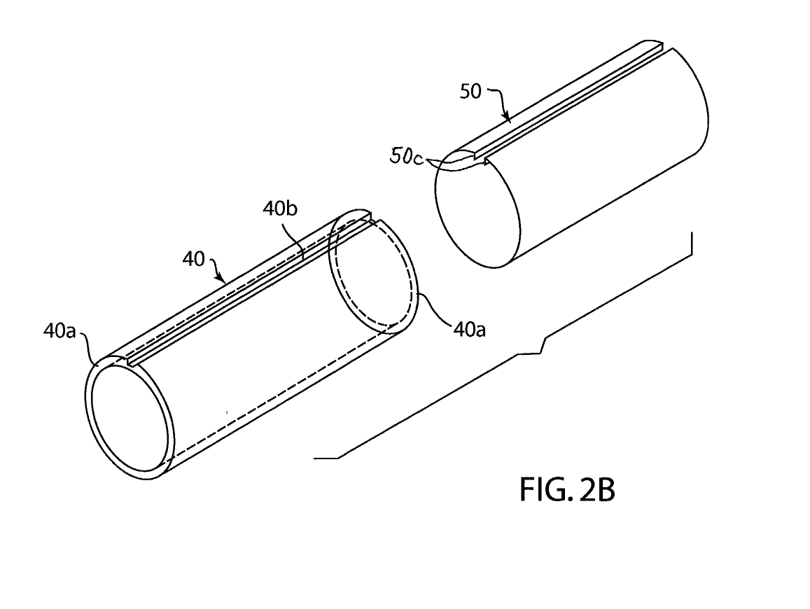

The tank 12 is connected by conduit 16 to an inlet 20 of the RRO filtration device 10. The RRO filtration device 10 is shown including a concentrate outlet 22 that is connected by conduit 24 to a pumping means 26 that pumps the concentrate at a controlled flow rate for collection in a receiving tank or container (not shown). An open/close valve 28 is disposed in the conduit 24 to close it off when it is desirable to force as much liquid as possible through the RO filter member or when operation of the device 10 ceases for maintenance. The pumping means 26 can comprise a peristaltic pump, roller pump, syringe pump, or other pump that can provide a controlled flow of concentrate from the outlet 22 as described below. Although a single tubular inlet 20 and tubular outlet 22 are discussed for the embodiment of FIG. 2, multiple inlets 20 of any kind can be positioned axially spaced apart along the length of the outer tubular body 56 and thus along the length of annulus 60 as shown in dashed lines in FIG. 2 to provide the liquid thereto in other embodiments of the invention. Similarly, multiple outlets 22 of any kind can be provided positioned at suitable locations. The RRO filtration device 10 includes a permeate outlet 30 through which the permeate is collected into a receiving tank or container (not shown).

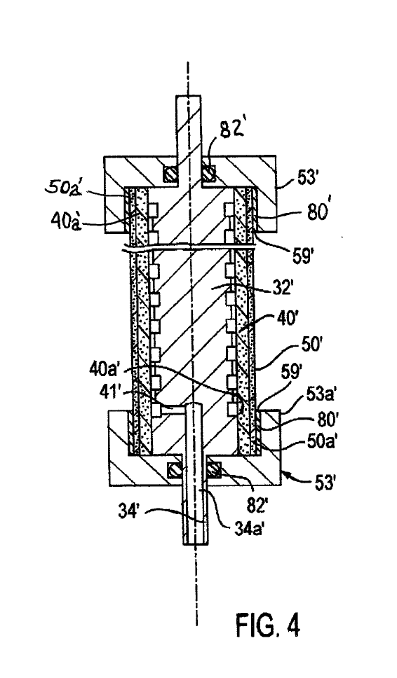

The RRO filtration device 10 comprises a rotatable inner filter-carrying body 32 having a central longitudinal axis A of rotation. The inner body 32 is illustrated in FIG. 2 as comprising a generally cylindrical lower end section 32a and a cylindrical, upper end section 32b, both sections being made of metal, such as aluminum, plastic, or other suitable material. The lower section 32a and upper section 32b are press fit or otherwise attached to a cylindrical metal (e.g. steel) rotatable shaft 34. A plurality (e.g. 4) of bolts or dowel rods 35 extend between the sections 32a, 32b to align them and/or attach them one to the other. An O-ring 37 can be present at the interface between the inner body end sections 32a, 32b. An alternative inner body construction is shown in FIG. 4 and described herebelow.

The inner body 32 includes a porous support member 40 disposed on a reduced-diameter, permeate collection surface 36 of the inner body 32 with the opposite axial ends 40a of the support member disposed proximate annular, radially-extending shoulders 38, 39 of the inner body. The support member 40 typically comprises a cylindrical tubular sleeve of plastic, metal or other material that has inter-connected porosity extending from its outer diameter surface to its inner diameter surface so that permeate can pass through the support member 40.

A reverse osmosis semi-permeable filter member 50 is disposed on the sleeve 40 and includes an axially elongated, annular outer surface 50s extending in a direction of longitudinal axis A and peripherally about the inner body 32 and support sleeve 40. For example, the semi-permeable filter member 50 can be a separate flat membrane sheet that is wrapped on and about the outer cylindrical surface of sleeve 40 so that the outer surface 50s assumes a general or near-cylindrical configuration on the sleeve 40. The filter member 50 can be disposed on the sleeve 40 by any suitable technique. The RO filter member 50 alternately may comprise a RO material coated or otherwise applied or deposited on the sleeve 40 as an axially elongated, annular coating or layer. In the event the RO filter member comprises a flat sheet wrapped on and about the sleeve 40, the sleeve may include an axially extending slot 40b to receive the opposite sides 50c of member 50, FIG. 2B. The RO filter member 50 can be adhesively secured and sealed on the cylindrical surface of the support sleeve 40 to prevent leakage of high pressure liquid at opposite sides (received in slot 40b) and at opposite annular, axial ends 50a of the filter member 50. A suitable adhesive to be used to this end can comprise silicone adhesive/sealant or epoxy adhesive/sealant.

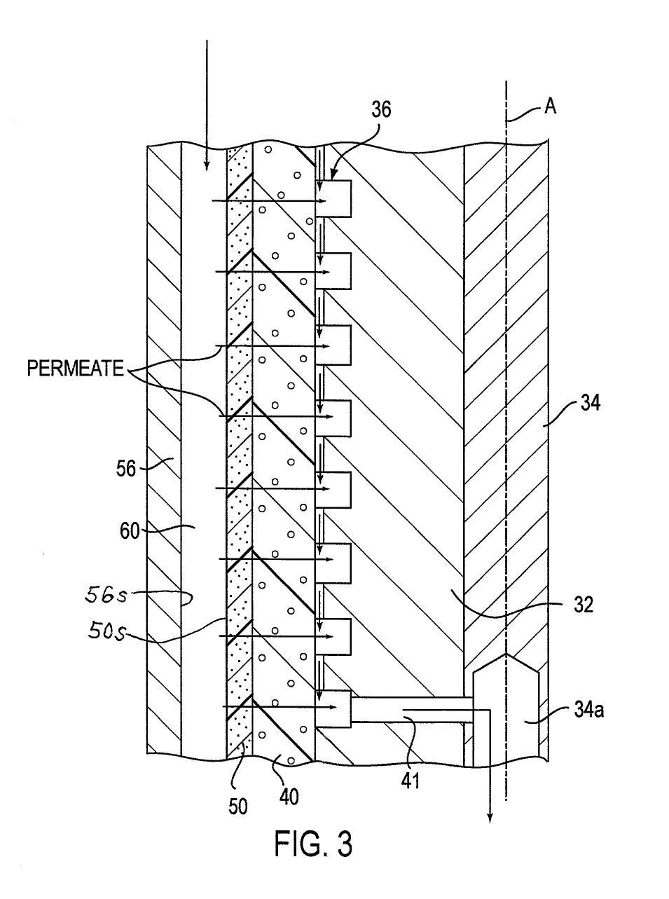

The permeate collection surface 36 of the inner body 32 includes a pattern of circumferentially extending horizontal grooves 36a and axially extending vertical grooves 36b that collect permeate passing through the RO membrane 50 and the support member 40, as shown in FIG. 3. The vertical grooves can be spaced 45 degrees apart circumferentially about the inner body or by any other circumferetnial spacing and direct the permeate to a radially-extending passage 41 in the inner body 32. The passage 41 extends through a wall of the shaft 34 into a counterbore 34a therein, the counterbore terminating in the outlet 30 where the permeate is collected. The permeate collection surface 36 can be formed by any suitable grooves, channels, and like features or by separate elements provided on the surface 36 to this end. For example, one or more wires wound between the sleeve 40 and the inner body 32 can be provided to this end on surface 36, which may be flat in this event. Furthermore, the grooves or channels 36a, 36b may be omitted altogether, so that the permeate passes through the length of the porous support sleeve 40 to passage 41.

The shaft 34 has opposite ends that are received in respective lower and upper end plates 54 as shown best in FIG. 2. An end of the shaft is connected to a motor or other means 57 for rotating the shaft 34 and thus the inner, filter-carrying body 32. The inner body 32 also may be rotated by a magnetic coupling, pulley drive or gear arrangement. The end plates 54 are held together by respective side plates 55 fastened therebetween by conventional fasteners. Alternately, rather than using side plates 55, the end plates 54 may be held together by an outer tubular body 56 itself fastened to the end plates 54.

An outer tubular body 56 of metal, plastic or other suitable material is disposed and sealed between the end plates 54 about the inner body 32. The outer body 56 includes an axially elongated, annular inner surface 56s that is spaced radially from the annular outer surface 50s of the RO filter member 50 and peripherally surrounds the outer surface 50s to provide a narrow gap or annulus 60 therebetween that receives the high pressure liquid to be filtered from inlet 20 connected to supply tank 12. The outer body 56 typically is disposed concentric about inner body 32, although the bodies 32, 56 do not need to be concentrically disposed. The narrow annulus 60 thus is defined between the outer, annular surface 50s of the filter member 50 and the inner, annular surface 56s of the outer body 56. In FIG. 2, the annular surface 50s is shown having a general right cylinder configuration by virtue of the filter member 50 being wrapped and held on the outer, right cylinder surface of sleeve 40, while the annular surface 56s is shown as having a right cylinder configuration in side elevation. The invention is not limited to cooperating right cylinder outer and inner surfaces 50s, 56s as shown in side elevation and can be practiced using other surface configurations. Such surfaces 50s, 56s can include (when viewed in side elevation) conical surfaces, wavy (curvilinear) surfaces (e.g. that define an hourglass or other curvilinear surface configuration having a circular transverse cross-section at each location along a longitudinal axis such as axis A), stepped diameter surfaces (e.g. that have different diameter sections arranged along their lengths), surfaces having an oval transverse cross-section at each location along a longitudinal axis, or any combination of different axisymmetric or non-axisymmetric surface geometries for the surfaces 50s, 56s. Surfaces of revolution, such as cylindrical, conical, and the like, are preferred for outer and inner surfaces 50s, 56s for ease of manufacturing and will yield concentric circles about longitudinal axis A when a transverse cross-section perpendicular to the longitudinal axis of each surface is taken. The gap or annulus 60 defined between the surfaces 50s, 56s can be of uniform width (radial dimension in FIG. 2) along its length or it can vary in width along its length. The inner, filter-carrying body 32 is shown having support sleeve 40 with a general right cylinder outer surface 40s. It is apparent that the inner body 32 and the sleeve 40 can have other configurations in practice of the invention which can be selected in dependence on the shape of the filter member 50 to be used.

The pressure of the liquid to be filtered in annulus 60 typically is in a range of about 10 to about 40 atmospheres, which is high enough to cause permeate to flow by reverse osmosis through the RO filter member 50 and then through the porous support member 40 and grooves 36a, 36b into permeate outlet 30. The gas pressure applied on the liquid in supply tank 12 is controlled at a high superambient pressure to this end and to force liquid through inlet 20 into the annulus 60. The inlet 20 can be non-tangentially or tangentially oriented relative to outer body 56 and annulus 60. The inlet 20 can comprise a configuration other than the tubular inlet illustrated, such as being a slot or opening in outer body 56 with a fluid fitting received or communicated to the slot or opening.

As mentioned above, an end of the shaft 34 is connected to a motor or other means 57 for rotating the shaft 34 and thus the inner filter-carrying body 32 in the outer body 56. The shaft 34 includes first and second high pressure shaft seals 62 where the shaft passes through the end plates 54 to avoid leakage of high pressure liquid. For purposes of illustration and not limitation, a suitable shaft seal 62 comprises a high pressure seal available as PAC-SEAL Type 21 (Model 168) from Flowserve Corporation, Elgin, Ill. Such a high pressure shaft seal can accommodate 250 psi maximum unbalanced maximum pressure and 650 psi maximum balanced pressure, and shaft speeds of 5000 feet/minute. Other types of high pressure shaft seals, such as lip seals and other high pressure seals, can be used in practice of the invention.

In an alternative embodiment of the invention illustrated in FIG. 2A where like features are represented by like reference numerals, the motor or other means 57 for rotating the shaft 34 can be located at the same end as the permeate outlet 30. The shaft 34 thereby extends through only the lower end plate 54, eliminating the need for a high pressure seal at the upper end of shaft 34, which upper end can be mounted in a suitable bearing in upper end plate 54. The lower end of the shaft 34 can include a pulley 51a on the exterior surface to be driven in rotation by a belt or chain 51b connected to output shaft of the motor 57.

The inner, filter-carrying body 32 is rotated at a rotational speed effective to generate vortices in the high pressure liquid in the annulus 60. For example, Taylor vortices are well known and comprise pairs of counter-rotating axisymmetric toroidal vortices that can be generated in the liquid in annulus 60 between the differentially-rotating surfaces 50s, 56s. The critical conditions at which these Taylor vortices first appear in the liquid in the annulus 60 depends on the Taylor number, Tₐ, or rotating Reynold's number, Tₐ=Ωr₁d/n where Ω is the angular velocity of the inner body 32, d is the gap between the bodies (i.e. the radial width of the annulus 60), r₁ is the radius of the outer surface 50s of the RO filter member 50, and n (nu) is the liquid's kinematic viscosity. Taylor vortices are described in the book, “Benard Cells and Taylor Vortices” by E. L. Koschmeider (Cambridge Univ. Press, 1993), the teachings of which are incorporated herein by reference. At higher rotational speeds, typically 10% to 50% higher than the speed necessary to generate Taylor vortices, the vortices become wavy, rather than axisymmetric. These vortices are referred to by some as wavy Taylor vortices, while others refer to them simply as wavy vortices. There are other vortical regimes, such as turbulent vortices and modulated wavy vortices, that may be generated in the liquid in annulus 60 by relative rotation between surfaces 50s, 56s. Such vortices are described in the book, “Benard Cells and Taylor Vortices” by E. L. Koschmeider (Cambridge Univ. Press, 1993) and in “Flow regimes in a circular Couette system with independently rotating cylinders”, by C. D. Andereck et al., Journal of Fluid Mechanics, Vol. 164, pp. 155-183, 1986, the teachings of which are incorporated herein by reference.

The invention is practiced by generating vortices of any of the above types in the high pressure liquid in annulus 60 between the differentially-rotating surfaces 50s, 56s. It should be noted that the invention envisions rotating the outer body 56 and inner body 32 at different rpm's to this end.

Rotation of at least the inner, filter-carrying body 32 imparts angular velocity to the interior of the liquid in the annulus 60. Not only does a high shear result in the liquid near the RO filter membrane 50, but also the shear is decoupled from any axial flow (cross-flow) of the liquid provided through the annulus 60 along its length, since the rotational speed is controlled independent of the flow rate. The vortices act to further increase the shear near the RO filter member 50 by redistributing the circumferential liquid momentum resulting in much higher shear near the RO filter member than would occur with no vortices, as described in “Simulation of Taylor-Couette Flow. Part 2. Numerical results for wavy-vortex flow with one travelling wave” by P. S. Marcus, Journal of Fluid Mechanics, Vol. 146, pp. 65-113, 1984, and “Azimuthal velocity in supercritical circular Couette flow”, by S. T. Wereley et al., Experiments in Fluids, Vol. 18, pp. 1-9, 1994, the teachings of which are incorporated herein by reference.

In practicing a method embodiment of the invention, a relatively high flow rate of the liquid from the tank 12 through the inlet 20 into the annulus 60 and a relatively low flow of concentrate from the concentrate outlet 22 are provided, while maintaining a high liquid pressure in the annulus 60 for reverse osmosis filtration. The desired flow rates into and out of the annulus 60 with high pressure in the annulus 60 are controlled by pumping the concentrate from concentrate outlet 22 at a controlled flow rate that is typically much less than the flow rate through the inlet 20 into the annulus 60. As mentioned above, pumping means 26 is provided to this end. Control of flow rates in this manner provides a through-flow mode of operation of the filtration device.

However, the invention can be practiced to provide a batch mode of operation where liquid flows continuously in the inlet 20 and permeate flows continuously out of the permeate outlet 30, but the concentrate is removed the concentrate outlet 22 only periodically. The concentrate outlet 22 may be closed to provide a dead-end mode of operation as well where liquid flows only in the inlet 20 and permeate flows out of the permeate outlet 30.

An alternative construction of the inner, filter-carrying body is illustrated in FIG. 4 where like reference numeral primed are used to designate like features of FIGS. 1-2. In FIG. 4, the inner body 32′ comprises a one-piece body having first and second end caps 53′ fastened to the inner body. The end caps form annular (circular) grooves 59′ about the inner body that receive the annular, axial ends 40a′ and 50a′ of the support sleeve 40′ and the wrapped-on RO filter member 50′. An adhesive 80′ is applied between the annular, axial ends 50a′ of the member 50′ and axially-extending tubular lips 53a′ of the end caps 531 to pot the ends 50a′ of the RO filter member against leakage of high pressure liquid. An annular O-ring 82′ is provided between each end cap 53′ and the shaft 34′ for similar purposes.

The following Example is offered to further illustrate the invention without limiting the scope thereof.

### EXAMPLE

The rotating reverse osmosis apparatus illustrated in FIGS. 1-2 was assembled and tested using wastewater that models wash water, condensate and urine composition typical of that on a spacecraft, a potential application of this invention. The simplified composition and properties of the input wastewater are set forth in Table I. In addition to ammonium ions from urine, the wastewater contained body soap and ions.

TABLE I

| | | Total | Diffusion |
|---|---|---|---|
| | Concentration | Nitrogen | Coefficient |
| Component | (mg/L) | (mg/L) | (m²/sec) |
| (NH₄)₂CO₃ | 3449.1 | 100 | 1.42 × 10⁻⁹ |
| | | 6 | |
| NASA body | 190.6** | 7.8 | 0.89 × 10⁻⁹ |
| Soap* | | | |
| NaCl | 1000 | 0 | 1.61 × 10⁻⁹ |

*The detergent molecule in NASA body Soap is C₁₅H₃₀O₄NSNa
**Concentration is based on the net detergent concentration as linear alkylbenzene sulfonate (LAS).

The rotating filter-carrying inner body comprised a commercially available thin film polymeric RO membrane (available as ESPA membrane from Hydranautics Corporation, Oceanside, Calif.) wrapped and adhesively bonded onto a porous plastic cylindrical support sleeve that was disposed on an aluminum inner body itself mounted on a rotatable steel shaft. The porous plastic sleeve comprised a high density polyethylene sleeve with a pore size of 5 microns, a porosity of 68% by volume based on total volume of sleeve, an outer diameter of 2.41 cm, and inner diameter of 2.06 cm. The RO membrane had a water permeability of 1.6×10⁻¹¹ m²-sec/kg (measured using pure water). The as-wrapped outer radius of the generally cylindrical RO membrane was 2.41 centimeter (cm). The inner radius of the outer cylindrical body was 2.88 cm, providing a uniform annulus radial width of 0.47 cm from the inlet to the concentrate outlet. The axial length of the RO membrane surface was 12.70 cm, and the overall length of the filter chamber (defined between end plates 54) was 23.2 cm. A DC electric motor was used to rotate the shaft and the inner, filter-carrying body thereon at rotational speeds of 1 to 180 rpm.

The wastewater input solution was supplied from a nitrogen pressurized supply tank. The tank was nitrogen pressurized to about 10 atmospheres above atmospheric pressure (about 150 psi). The wastewater entered the inlet to flow axially along the RO filter membrane to the concentrate outlet. The flow rate through the inlet was in the range of 2 to 8 mL/min, while the flow rate through the concentrate outlet was in the range of 0 to 2.5 mL/minute as controlled by a peristaltic pump. The permeate passed through the RO filter membrane and was directed into the counterbore 34a at the lower end of the steel shaft 34, exiting via permeate outlet 30. Test time was 3 hours of operation.

After priming the apparatus with pure water, the wastewater from the pressurized tank was introduced into the annulus. Permeate flux and rejection of contaminants (i.e. the components shown in Table I) were measured using graduated cylinders to collect permeate and concentrate. The solute concentrations in the concentrate and permeate were measured several times during filtration. After each experimental trial, all of the concentrate was removed from the apparatus to measure the final solute concentration. The viscosity and density were corrected for temperature, which varied less than 1 degree C. during the trails.

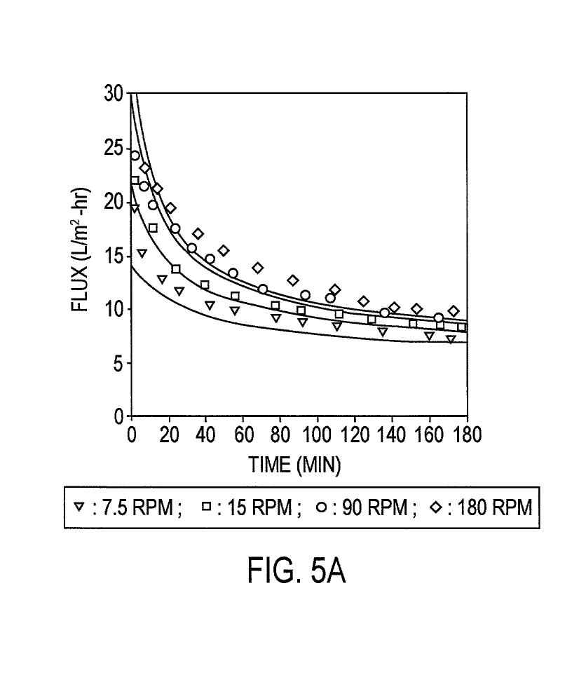

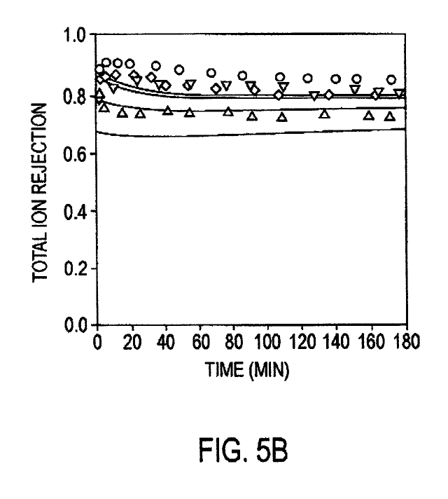

The permeate flux and ion rejection were measured under a range of transmembrane pressures and rotational speeds. In addition, the process was modeled computationally using the method described in “Rotating reverse osmosis: a dynamic model for flux and rejection”, by S. L. Lee and R. M. Lueptow, Journal of Membrane Science, Vol. 192, pp. 129-143, Oct. 15, 2001, the teachings of which are incorporated herein by reference. FIGS. 5A and 5B show that even a small increase in rotational velocity from 7.5 rpm to 15 rpm (at a transmembrane differential pressure of 1000 kPa for a time of 3 hours of operation at a concentrate flow rate of 0 mL/min) yielded greater flux and ion rejection than a much larger increase in rotational velocity from 90 to 180 rpm. The observed increase is attributed to the generation of Taylor vortices which occur in the test apparatus between 7.5 rpm to 15 rpm. Specifically, the model predicts that the flux and ion rejection will suddenly increase at a rotational speed of 9.2 rpm because of the flow transition from non-vortical flow to vortex flow. For example, the flux in the non-vortical flow regime is predicted to be 10 L/m²/hr at 9.2 rpm and 1300 KPa of pressure. A small increase of rotational speed results in a formation of vortices and an increase in the flux to 12 L/m²/hr at 9.3 rpm. However, the flux and ion rejection increase only slightly with rotational speed over 80 rpm. Therefore, a rotational speed sufficient to generate Taylor or other vortices in the annulus can be used to maintain a high flux and ion rejection across the RO filter membrane.

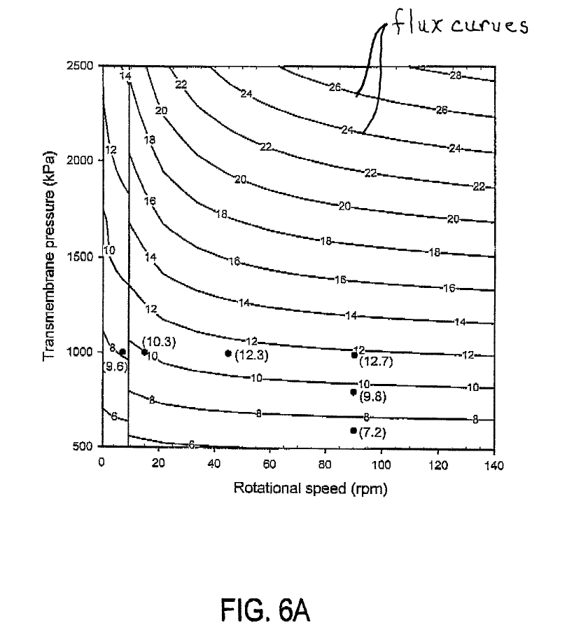

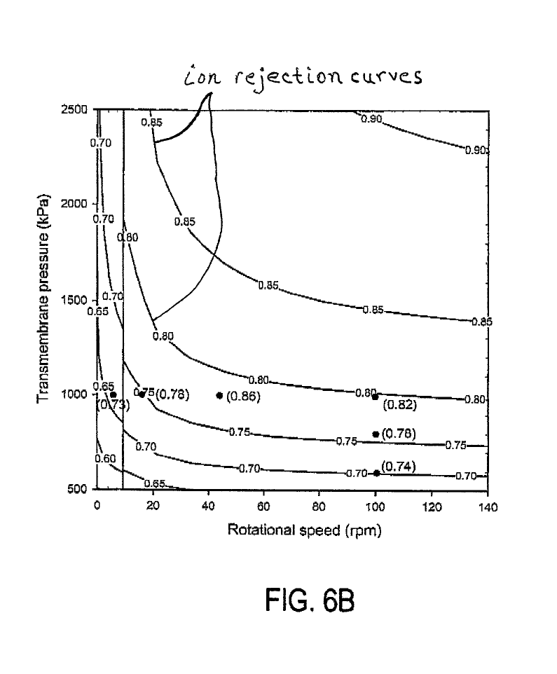

Referring to FIGS. 6A and 6B, which show the model results and several experimental data points for the permeate flux (FIG. 6A) and ion rejection (FIG. 6B) for a concentrate flow rate of 0 mL/min, an increase in the transmembrane pressure results in higher flux and ion rejection for both non-vortical flow and vortex flow conditions, but the effect depends on the rotational speed. For example, the flux is about 10 L/m²/hr at 1000 KPa of transmembrane pressure and 20 rpm. Doubling the transmembrane pressure increases the flux by 80%. Doubling the rotational speed increases the flux by only 10%. However, the flux increased by 105% by doubling the pressure and rotational speed simultaneously. Thus, increasing the transmembrane pressure and rotational speed enhances flux more than simply increasing rotational speed alone.

While the invention has been described in terms of embodiments thereof, it is not intended to be limited thereto and modifications and changes can made therein without departing from the spirit and scope of the invention as set forth in following claims.

I claim:

1. Rotating reverse osmosis filtration apparatus, comprising
a) a rotatable inner body having an axis of rotation, said inner body having a reverse osmosis filter member disposed thereon, said filter member having an outer surface,
b) an outer body disposed about said inner body and having an inner surface spaced from said outer surface of said filter member to provide an annulus therebetween to receive a liquid to be filtered,
c) an inlet for introducing said liquid to said annulus,
d) a source of said liquid under pressure communicated to said inlet, said liquid being under a high enough pressure in said annulus to cause permeate to flow by reverse osmosis through said filter member to a permeate outlet,
e) means for rotating said inner body, and
f) means for collecting said permeate from a permeate outlet.

2. The apparatus of claim 1 wherein said inner body is rotated at a rotational speed effective to generate vortices in said liquid under pressure in said annulus.

3. The apparatus of claim 1 including means for pumping concentrate at controlled flow rate from a concentrate outlet disposed downstream from said inlet.

4. The apparatus of claim 3 wherein said means for pumping comprises a peristaltic or syringe pump.

5. The apparatus of claim 1 wherein said source comprises a gas pressurized vessel containing said liquid.

6. The apparatus of claim 1 wherein said source comprises a liquid pump.

7. The apparatus of claim 1 wherein said inner body includes an outer, permeate-collection surface on which a porous support member is disposed to support said filter member against said pressure of said liquid in said annulus while permitting said permeate to pass to said collection surface.

8. The apparatus of claim 7 wherein said outer, permeate collection surface comprises one or more grooves that communicate to a permeate collection passage in said inner body.

9. The apparatus of claim 7 wherein said porous support member comprises a porous plastic or metal tubular sleeve disposed on said inner body.

10. The apparatus of claim 6 wherein said reverse osmosis filter member is wrapped on said porous support member.

11. The apparatus of claim 6 wherein said reverse osmosis filter member is coated on said porous support member.

12. The apparatus of claim 10 wherein said reverse osmosis filter member includes opposite annular ends, each opposite annular end of said filter member being received and sealed in a respective annular groove.

13. The apparatus of claim 12 wherein said inner body is disposed on a rotatable shaft and each annular groove is formed by an end cap attached to said shaft.

14. The apparatus of claim 12 wherein said inner body is disposed on a rotatable shaft and a high pressure shaft seal is disposed at a shaft end.

15. The apparatus of claim 1 including a plurality of inlets spaced along a length of said outer body to communicate with said annulus.

16. The apparatus of claim 1 including a plurality of outlets.

17. The apparatus of claim 1 wherein said annular outer surface and said annular inner surface each comprises a surface of revolution where a transverse cross-section thereof defines a circle.

18. The apparatus of claim 17 wherein said surface of revolution is selected from a right cylinder surface and a conical surface.

19. The apparatus of claim 1 wherein the liquid pressure in said annulus is about 10 to about 40 atmospheres.

20. A method of reverse osmosis filtration, comprising
disposing a rotatable inner body having a reverse osmosis filter member thereon in an outer body such that an outer surface of said filter member is spaced from an inner surface of said outer body to provide an annulus therebetween to receive a liquid to be filtered,
providing a liquid to be filtered in said annulus under a high enough pressure in said annulus to cause permeate to flow by reverse osmosis through said filter member to a permeate outlet,
rotating said inner body, and
collecting said permeate from a permeate outlet.

21. The method of claim 20 including rotating said inner body at a rotational speed effective to generate vortices in said liquid under pressure in said annulus.

22. The method of claim 20 including pumping concentrate at controlled flow rate from a concentrate outlet disposed downstream from said inlet.

23. The method of claim 20 including disposing a porous support member on said inner body and disposing said reverse osmosis filter member on said porous support member so that said reverse osmosis filter member is supported against said pressure of said liquid in said annulus while permitting said permeate to pass to said collection surface.

24. The method of claim 20 including sealing each of opposite annular ends of said reverse osmosis filter member in a respective annular groove.

25. The method of claim 20 including introducing said liquid to said annulus through a plurality of inlets spaced along the length of said outer body to communicate with said annulus.
